(19) United States
(12) Patent Application Publication
(10) Pub. No.: US 2018/0278321 A1
(43) Pub. Date: Sep. 27, 2018

(54) RADIO TRANSMISSION BETWEEN AN AIRCRAFT AND ITS ENVIRONMENT, THROUGH THE WINDOW OF SAID AIRCRAFT

(71) Applicant: LUFTHANSA SYSTEMS GMBH & CO. KG, RAUNHEIM (DE)

(72) Inventors: JÖRG LIEBE, WIESBADEN (DE); PETER HOMMEL, BAD HOMBURG (DE)

(21) Appl. No.: 15/557,436

(22) PCT Filed: Feb. 16, 2016
(86) PCT No.: PCT/EP2016/053277

§ 371 Date: Sep. 11, 2017

(30) Foreign Application Priority Data
Mar. 12, 2015 (DE) 10 2015 204 463.7

(51) Int. Cl. H04B 7/185; H01Q 1/28

(52) U.S. Cl. CPC H04B 7/18508; G08G 5/0004; H04B 7/18504; H01Q 1/28

(57) ABSTRACT

The invention relates to a method for position-independent transmission and reception of data to and from a high-capacity passenger aircraft (10), characterised by the steps of: installing, in the vicinity of a window of said passenger aircraft (10), at least one antenna (16) designed for communicating with an airborne communications hub (22), transmitting and/or receiving the data between at least the antenna (16) and an airborne communications hub (22) during the flight, and transmitting the data within the aircraft (10), between the antenna (16) and a routing device (20) connected to said antenna (16).

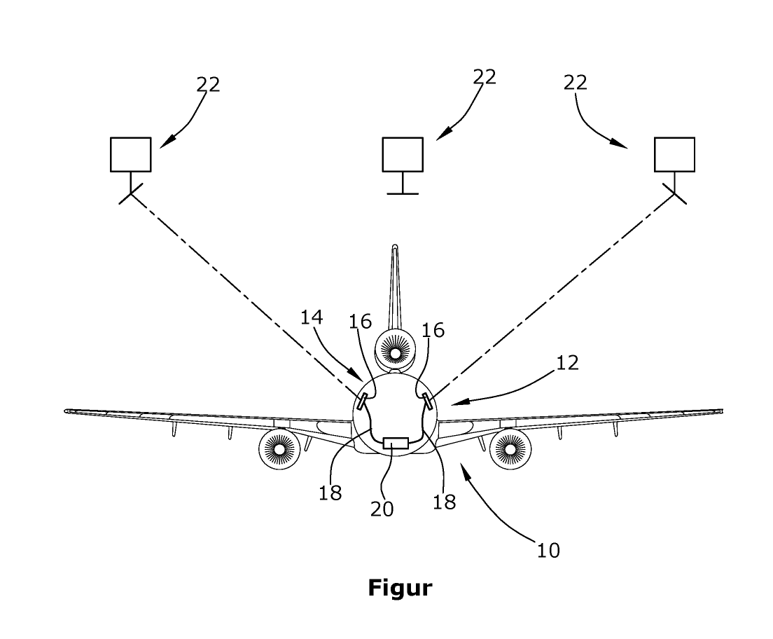

The invention relates to a method for transmitting data from a large-capacity passenger aircraft.

Typically, data are transmitted by radio between a large-capacity passenger aircraft and a ground station or other aircraft. The range of such data transmission by radio is limited by the range of the radio transmission. It is further known that modern large-capacity passenger aircraft communicate with satellites via radio so as to allow for telephone communication or surfing on the Internet during flight. For this purpose, satellite antennas must be installed separately on the outside of the aircraft, which is technically complicated and costly. A retrofit installation of such satellite antennas has to pass a tedious and complex approval procedure.

There is a need for making a position-independent transmission and receipt of data possible with a large-capacity passenger aircraft. This is of particular importance with respect to the transmission of flight data, such as for example the altitude, the airspeed and the position of the aircraft, so as to be able to know or find the position of the aircraft in a case of emergency. Using conventional radio communication with ground stations and/or other aircraft, this is not possible, since no large-area communication is possible, for example over large sea areas. On the one hand, use of broadband satellite links is not sufficiently safe for that purpose, since passengers could get access to data communication. On the other hand, the broadband satellite communication presently used is not available throughout large areas either, since access is made to geostationary satellites in the equator area so that no data link can be established in the polar areas. Moreover, broadband satellite communication can only be used if an aircraft has been equipped with corresponding transmission and receiving means.

The method of the present invention is defined by the features of claim 1.

Accordingly, at least one transceiver antenna for communication with a satellite is positioned in an aircraft in the vicinity of a window of the passenger cabin or the cargo space, respectively, such that the antenna is in visual contact with the outside through the window, so as to establish and maintain a data link between the antenna and a flying communication hub through the respective window during flight. A flying communication hub may be a satellite, preferably a LEO (Low Earth Orbit) satellite such as, for example, an Iridium satellite. A flying communication hub may further also be an aircraft flying at a high altitude or a drone (HAP—High Altitude Plane) flying at a high altitude. A data link for data transmission is established with the flying communication hub and maintained. It is a particularity of large-capacity passenger aircraft that the cockpit windows are particularly thick and strong and are not suited for radio communication through the windows, whereas the windows of the passenger cabin or of the cargo space do allow for such radio communication. It is decisive that the antenna is arranged in the vicinity of the window such that a direct link between the antenna and the flying communication hub exists through the window (visual contact), so that the radio waves transmitted between the antenna and the flying communication hub are transmitted through the window. LEO satellites such as Iridium, Global Star or OneWeb, for example, are satellites with a low-earth orbit at an altitude of about 200-2000 km. High Altitude Planes (HAP) are flown as manned or unmanned aircraft to altitudes of about 20000 m, where they are assigned to a predefined range which the leave only for refueling, if possible.

Preferably, one antenna is respectively installed in at least one window of the passenger cabin or the cargo space on opposite sides, so that a data link can be maintained with at least two different flying communication hubs. Preferably, the antennas are arranged in windows of the galley, the lavatory or in front of emergency exits. The antennas are mounted to the windows either in a detachable or a fixed manner, e.g. by means of an adapter element releasably attached to the window or the window frame. It is conceivable, for example, that the adapter element is clamped or glued into the window frame or the part of the wall lining surrounding the window. For this purpose, the adapter element may be provided with suitable clamping elements. As an alternative, the antenna and/or the adapter element may be glued onto the window, provided that the adhesive bond can be disbonded without any residues.

The antennas can be mounted in a simple manner in the vicinity of the window so that a retrofitting installation is possible also in such aircraft whose fuselages are not equipped with corresponding transmission and receiving devices for satellite communication or communication with aircraft flying at high altitudes.

All antennas have a communication link to a routing means that is installed as a separate unit on board of the aircraft. The routing means may be a modem or a repeater of a computer network. Typically, the communication of the antenna with the routing means is wired, but may also be wireless.

From the routing element a communication link to the cockpit, i.e. to the components in the cockpit that detect flight data, may be established in order to transmit flight data via the antennas. Flight data are, for example, the position, the attitude, the airspeed and/or the altitude of the aircraft. The flight data are preferably automatically transmitted at predefined intervals so as to be able to quickly determine the position of the aircraft and its flight condition in a case of emergency.

As an alternative or in addition, the routing means may communicate via WLAN with a reader for credit cards and/or bank cards within the passenger cabin so as to verify credit or bank card data of a passenger during flight. The data acquired by the card reader are transmitted to the LEO satellites via the routing means and the antennas and are routed from there to an appropriate ground station that verifies the relevant data. This may be used to allow a passenger to purchase an article on board of the aircraft during the flight and the hand over the article at the airport after landing.

No communication with the Internet and in particular no streaming of audio and/or video contents is intended via the antennas. Only selected data such as, for example, flight data, are intended to be transmitted. This is possible by means of the antennas positioned in the vicinity of the windows.

This offers the decisive advantage that the communication means of the present invention can be retrofitted quickly and in a simple manner and does not have to pass the common approval procedures for components permanently installed in a large-capacity passenger aircraft. Rather, the antennas of the present invention and the routing means are “loose equipment” that requires no approval.

A further advantage may be that a decoupling from the broadband communication used by passengers exists, for example when phones are used during the flight or while surfing on the Internet. Therefore, data communication as provided by the invention is particularly safe, since passengers have no possibility to interfere with data transmission.

An embodiment of the invention will be explained in detail hereunder with reference to the FIGURE.

The FIGURE is a schematic simplified illustration of a large-capacity passenger aircraft 10 which may be a passenger aircraft or a cargo aircraft. Windows are arranged in the fuselage area on opposite sides 12, 14. In at least one window of the passenger cabin or of the cargo space, an antenna 16 is detachably mounted on each side 12, 14 of the aircraft 10. The antennas 16 are clamped into the recess for the window frame by means of an adapter element not shown in the FIGURE.

Each antenna 16 is connected by a cable 18 to a routing means 20 in the form of a WLAN modem. The routing means 20 is configured for radio communication (WLAN) with a credit card reader in the passenger cabin. Further, the modem 20 is connected via radio communication, not illustrated in the FIGURE, to an apparatus containing flight data in the cockpit of the aircraft, so as to transmit flight data via the antennas 16. A transmission of data from the routing means 20 into the cockpit is excluded for reasons of safety.

The antennas 16 are designed for radio communication with flying communication hubs in the form of Iridium satellites 22. Each of the two antennas 16 communicates with another satellite 22 of different sides of the aircraft 10 so that communication with at least two satellites 22 occurs at the same time. The data transmitted are sent from the satellites 22 to ground stations in a conventional manner and are transmitted from there to a centre for acquiring flight data or to a centre for verifying the credit card data, for example.

It is to be considered a decisive aspect of the invention that the device can be retrofitted in a simple manner to practically any large-capacity passenger aircraft without having to provide fixed connections with parts of the aircraft. The antennas may be clamped into the recess for the window frame and the routing means 20 may be positioned at an optional location in the aircraft 10. Further, a variant is conceivable according to which each of the antennas 16 communicates with a routing means 20 of its own, the routing means of different antennas communicating with each other in a wireless manner.

1. A method for position-independent transmission and receipt of data with a large commercial aircraft, characterized by the steps of:
installing at least one antenna in the commercial aircraft in a window or in close proximity thereof, said antenna being designed for communication with a flying communication hub,
transmitting and/or receiving the data between at least the antenna and a flying communication hub during flight, and
transmitting the data within the aircraft between the antenna and a routing means connected with the antenna.

2. The method of claim 1, wherein at least one antenna is installed, respectively, in a window or in close proximity thereof on opposite sides of the aircraft.

3. The method of claim 1, wherein each antenna is connected by wire with the routing means, and the routing means is configured for wireless communication with a data source.

4. The method of claim 1, wherein each antenna has a routing means assigned thereto that communicates with the antenna, and the routing means is configured for wireless communication with a data source.

5. The method of claim 1, wherein each antenna is installed in or in close proximity of a respective window that is not fixedly assigned to a passenger seat.

6. The method of claim 1, wherein the antenna is installed at a window of a galley, a lavatory and/or an emergency exit.

7. The method of claim 1, wherein each antenna is mounted to the window in a detachable but fixed manner.

8. The method of claim 1, wherein each antenna is mounted to the window at a distance of 10 cm at most, such that a direct visual contact exists from the antenna outwards through the window.

9. The method of claim 1, wherein a communication link to different communication hubs is maintained with antennas on different sides of the commercial aircraft.

10. The method of claim 1, wherein flight data, such as, for example, information on position, altitude and/or speed of the aircraft, are transmitted automatically at regular intervals to a communication hub via the antenna.

11. The method of claim 1, wherein a secure data link exists from the cockpit of the aircraft to the antennas via the routing means for the transmission of the flight data, without it being possible to transmit data from the routing means into the cockpit.

12. The method of claim 1, wherein the routing means communicates wirelessly with a credit card or bank card reader within the aircraft.

13. The method of claim 1, wherein communication with the Internet and in particular for streaming audio and/or video data via the antenna is inhibited.

14. The method of claim 1, wherein the flying communication hub is a satellite, for example a Low Earth Orbit (LEO) satellite, or an aircraft flying at a high altitude (High Altitude Plane—HAP).
